(19) United States
(12) Patent Application Publication
(10) Pub. No.: US 2026/0304473 A1
(43) Pub. Date: Oct. 1, 2026

(54) WIRELESS APPARATUS AND WIRELESS COMMUNICATION METHOD

(71) Applicant: NTT, INC., Tokyo (JP)

(72) Inventors: Akira KISHIDA, Musashino-shi (JP); Kengo NAGATA, Musashino-shi (JP); Yusuke ASAI, Musashino-shi (JP); Yasushi TAKATORI, Musashino-shi (JP)

(73) Assignee: NTT, INC., Tokyo (JP)

(21) Appl. No.: 18/880,944

(22) PCT Filed: Jul. 7, 2022
(86) PCT No.: PCT/JP2022/026955

§ 371 Date: Jan. 3, 2025

(51) Int. Cl. H04W 74/0816; H04W 74/04; H04W 76/15

(52) U.S. Cl. CPC H04W 74/0816; H04W 74/04; H04W 76/15

(57) ABSTRACT

A wireless apparatus includes a communication unit, a first calculation unit, a second calculation unit, and a transmission control unit. The communication unit wirelessly communicates with another wireless apparatus using a plurality of links established between the wireless apparatus and the other wireless apparatus. The first calculation unit calculates a frame exchange period including a time period required for frame transmission to the other wireless apparatus. The second calculation unit calculates a communicative period indicating a time period until the start of a service period during which a transmission opportunity is given, the second calculation unit calculating the communicative period for the first link when the service period is scheduled for the first link. The transmission control unit performs the frame transmission on the first link when the frame exchange period is shorter than the communicative period for the first link.

### TECHNICAL FIELD

The present invention relates to wireless communication.

### BACKGROUND ART

A wireless local area network (LAN) is known as a communication system that wirelessly connects an access point and a terminal device. In a wireless LAN, each access point and terminal performs carrier sense based on, for example, carrier sense multiple access with collision avoidance (CSMA/CA), and wirelessly transmits a data frame when a transmission right is acquired.

A restricted target wake time (r-TWT) operation is being considered in IEEE 802.11be, which is being developed as a successor standard to IEEE 802.11ax. The r-TWT operation defines a mechanism for preferentially securing transmission opportunities for traffic with latency requirements. Traffic with latency requirements is also called low-latency traffic or latency-sensitive traffic, and is traffic that requires low latency and small jitter, such as traffic generated from real-time applications such as network games.

In the r-TWT operation, a terminal device exchanges frames with an access point during a service period (SP) set for itself by the access point, and communication of other terminal devices around the access point via a link, for which the service period is set, during a part of the service period is curbed. A terminal device can use a service period to wirelessly transmit data frames containing low-latency traffic to an access point. In this way, a service period is a period during which a terminal device specified by an access point is given a transmission opportunity, enabling the terminal device specified by the access point to preferentially transmit and receive data frames containing low-latency traffic. This service period is also called an r-TWT service period.

A terminal device that has acquired the transmission right before the start of the r-TWT service period checks whether it is possible to complete the transmission of the data frame it is about to transmit before the start of the r-TWT service period. If it is not possible to complete the transmission, the terminal device postpones the transmission of the data frame and starts transmitting the data frame after the end of the r-TWT service period.

Multiple terminal devices may postpone transmission due to the r-TWT service period. In this case, these terminal devices may start transmitting all at once after the r-TWT service period ends, and a collision may occur, making normal data transmission and reception impossible.

Backoff control may be used to avoid collisions caused by broadcasting data frames after the r-TWT service period ends. For example, a plurality of terminal devices that have postponed transmission performs carrier sense again after the r-TWT service period ends, and performs transmission once the transmission right is acquired again. In this case, even though the transmission right was acquired temporarily before the r-TWT service period, backoff control for acquiring the transmission right will be performed again, resulting in a decrease in frequency utilization efficiency.

### CITATION LIST

### Non Patent Literature

Non Patent Literature 1: IEEE P802.11be TM/D1.5, “35.9 Restricted TWT (r-TWT)”, Mar. 18, 2022.

### SUMMARY OF INVENTION

### Technical Problem

The occurrence of collisions and the decrease in frequency utilization efficiency as described above result in a deterioration in throughput and latency characteristics.

An object of the present invention is to provide a wireless communication technology that improves throughput and latency characteristics.

### Solution to Problem

A wireless apparatus according to one aspect of the present invention includes a communication unit, a first calculation unit, a second calculation unit, and a transmission control unit. The communication unit is configured to wirelessly communicate with another wireless apparatus using a plurality of links established between the wireless apparatus and the other wireless apparatus. The first calculation unit is configured to calculate a frame exchange period including a time period required for frame transmission to the other wireless apparatus. The second calculation unit is configured to calculate a communicative period indicating a time period until the start of a service period during which a transmission opportunity is given, wherein the second calculation unit is configured to calculate the communicative period for the first link when the service period is scheduled for the first link. The transmission control unit is configured to perform the frame transmission on the first link when the frame exchange period is shorter than the communicative period for the first link and attempt to perform the frame transmission on a second link different from the first link included in the plurality of links when the frame exchange period is longer than the communicative period for the first link.

### Advantageous Effects of Invention

According to the present invention, there is provided a wireless communication technology that improves throughput and latency characteristics.

### BRIEF DESCRIPTION OF DRAWINGS

FIG. 1 is a block diagram showing a communication system according to an embodiment.

FIG. 2 is a diagram showing link management information according to the embodiment.

FIG. 3 is a block diagram showing the hardware configuration of an access point according to the embodiment.

FIG. 4 is a block diagram showing the hardware configuration of a terminal according to the embodiment.

FIG. 5 is a block diagram showing the functional configuration of the access point and the terminal according to the embodiment.

FIG. 6 is a diagram illustrating transmission processing in the terminal according to the embodiment.

FIG. 7 is a diagram showing a situation in which a frame exchange period is shorter than a communicative period according to the embodiment.

FIG. 8 is a diagram showing a situation in which the frame exchange period is longer than the communicative period according to the embodiment.

FIG. 9 is a flowchart showing a wireless communication method according to the embodiment.

FIG. 10 is a block diagram showing the functional configuration of a terminal according to another example of the embodiment.

### DESCRIPTION OF EMBODIMENTS

Hereinafter, embodiments of the present invention will be described with reference to the drawings.

A multilink operation is being considered in IEEE 802.11be, which is being developed as a successor standard to IEEE 802.11ax. A multilink operation defines a mechanism for logically establishing multiple links using different frequency channels between an access point and a terminal device. In a multilink operation, access points and terminal devices wirelessly communicate with each other using established links. For example, a terminal device performs carrier sense based on CSMA/CA for each link, and wirelessly transmits a data frame to an access point using a link for which a transmission right has been acquired. An access point is also called a base station. Hereinafter, a terminal device will be simply referred to as terminal, and a frequency channel will be simply referred to as channel.

The access point and the terminal according to the embodiments described below support a multilink operation and establish multiple links between the access point and the terminal. Multiple links established between an access point and a terminal are called a linkset (LS). The access point and the terminal further support an r-TWT operation. The access point schedules, for each of terminals, r-TWT service periods during which a terminal is given or assigned an opportunity to transmit. During the r-TWT service period, each terminal can preferentially transmit data frames on the link for which the r-TWT service period is set. Each terminal can use an r-TWT service period to transmit data frames containing traffic with latency requirements.

A terminal according to one embodiment wirelessly transmits a data frame to an access point, for example, using the following procedure. First, the terminal. attempts to transmit a data frame using a first link included in a linkset. Specifically, the terminal performs carrier sense for the first link in order to check the state of a channel corresponding to the first link. The terminal determines that the channel is idle when the channel has not been used for a certain time period, and determines that the channel is busy when it is detected that the channel is in use. When the terminal confirms that the channel is idle, the terminal recognizes that it has acquired a transmission right for the first link. Once the terminal acquires the transmission right for the first link, the terminal checks whether an r-TWT service period is scheduled for the first link. If no r-TWT service period is scheduled for the first link, the terminal transmits the data frame on the first link. If an r-TWT service period is scheduled for the first link, the terminal checks whether the data frame transmission can be completed by the start of the r-TWT service period. If the transmission can be completed, the terminal transmits the data frame on the first link. If the transmission cannot be completed, the terminal attempts to transmit the data frame using a second link included in the linkset. Specifically, the terminal performs carrier sense for the second link. Once the terminal acquires a transmission right for the second link, the terminal checks whether an r-TWT service period is scheduled for the second link. If no r-TWT service period is scheduled for the second link, the terminal transmits a data frame on the second link. If an r-TWT service period is scheduled for the second link, the terminal checks whether the data frame transmission can be completed by the start of the r-TWT service period. If the transmission can be completed, the terminal transmits a data frame on the second link. If transmission cannot be completed, the terminal may attempt to transmit the data frame using a third link included in the linkset or may postpone the data frame transmission.

According to the above-described configuration, even if data frame transmission cannot be completed on a certain link by the start of the r-TWT service period set for that link, it is possible to transmit data frames on another link. Therefore, the frequency of occurrence of situations in which transmission is postponed due to the r-TWT service period is reduced, and it is possible to effectively avoid the occurrence of collisions or decrease in frequency utilization efficiency. As a result, throughput and latency characteristics are improved.

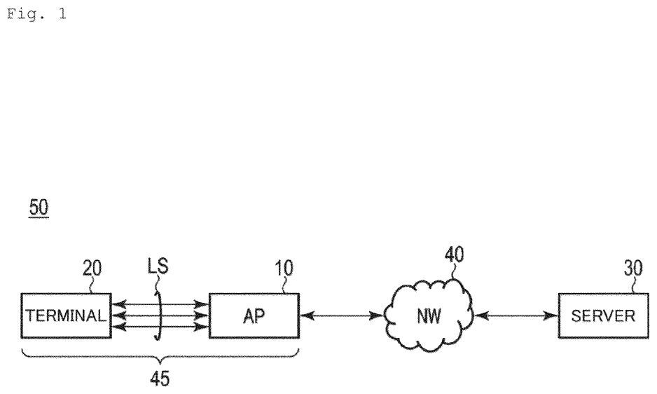

FIG. 1 schematically shows an example of the configuration of a communication system 50 including a wireless network 45 according to an embodiment. “System” and “network” mentioned herein may be used interchangeably. As shown in FIG. 1, the communication system 50 includes an access point (AP) 10, a terminal 20, and a server 30. The access point 10 and the terminal 20 are included in the wireless network 45.

The access point 10 is a wireless LAN access point. The access point 10 can be wirelessly connected to one or more terminals. The number of terminals wirelessly connected to the access point 10 changes dynamically. In the example shown in FIG. 1, the access point 10 is wirelessly connected to the terminal 20. The access point 10 establishes one or more links with the terminal 20 and uses the established links to wirelessly communicate with the terminal 20. The access point 10 is connected by wire to a communication network 40, which may include the Internet.

The terminal 20 is a wireless terminal equipped with a wireless communication function and operates as a wireless LAN client. Examples of wireless terminals include smartphones, mobile phones, tablet personal computers (PCs), desktop PCs, laptop PCs, and Internet of things (IoT) sensors/devices. The terminal 20 accesses the communication network 40 via the access point 10. For example, the terminal 20 exchanges data with a server 30 on the communication network 40 via the access point 10.

The server 30 is connected to the communication network 40. For example, the server 30 may be a service provider that provides services such as network games, and exchanges data related to the service with the terminal 20 via the communication network 40.

Wireless communication between the access point 10 and the terminal 20 is based on the IEEE 802.11 standard. Note that although wireless communication based on the IEEE 802.11 standard is described as an example in this specification, a wireless communication standard different from the IEEE 802.11 standard may be used.

The access point 10 and the terminal 20 support a multilink operation and an r-TWT operation. The access point 10 that supports a multilink operation is also called an access point multilink device (AP MLD), and the terminal 20 that supports a multilink operation is also called a non-access point multilink device (non-AP MLD).

The terminal 20 may be a terminal that follows a multilink operation with a plurality of links established, or may be a terminal that operates in a mode also called an enhanced multilink single radio (EMLSR) mode. A terminal that has established multiple links and follows a multilink operation can simultaneously transmit and receive frames on multiple links. A terminal operating in an EMLSR mode supports an operation on multiple links, but can only transmit frames on one link at a time. The terminal 20 operating in an EMLSR mode notifies the access point 10 that it operates in the EMLSR mode, and also notifies the access point 10 of a linkset available between the access point 10 and the terminal 20. Note that the terminal 20 can receive management frames, which will be described later, in parallel with each other on multiple links included in the linkset LS, but the terminal 20 may be able to receive a data frame on only one of the multiple links.

An example in which the terminal 20 operates in the EMLSR mode will be described below. The terminal 20 switches the link used for frame exchange between available links. The terminal 20 can stand by (listen) for multiple links. When a frame exchange is initiated by the access point 10, the access point 10 may select one link from among the available links and transmit a control frame to the terminal 20 notifying the start of frame exchange on the selected link. Upon receiving the control frame from the access point 10, the terminal 20 may determine to use the link on which the control frame has received, and may transmit a response to the control frame to the access point 10 on that link. Thereafter, the access point 10 and the terminal 20 exchange frames over that link. If the frame exchange is initiated by the terminal 20, the terminal 20 may initiate the frame exchange without transmitting a control frame as described above to the terminal 20.

The IEEE 802.11 standard defines the first layer and the media access control (MAC) sublayer of the second layer of the open systems interconnection (OSI) model. In the OSI model, a communication function is divided into seven layers (first layer: physical layer, second layer: data link layer, third layer: network layer, fourth layer: transport layer, fifth layer: session layer, sixth layer: presentation layer, and seventh layer: application layer). The data link layer includes, for example, a logical link control (LLC) layer and a MAC layer. The LLC layer forms an LLC packet by adding, for example, a destination service access point (DSAP) header and a source service access point (SSAP) header to data input from an upper layer. The MAC layer generates a MAC frame by adding a MAC header to an LLC packet, for example. The physical layer generates a wireless frame by adding, for example, a preamble and a physical layer (PHY) header to the MAC frame. Here, processing for the MAC sublayers the first layer and the second layer defined by the IEEE 802.11 standard will be mainly explained, and explanation of processing for other layers will be omitted.

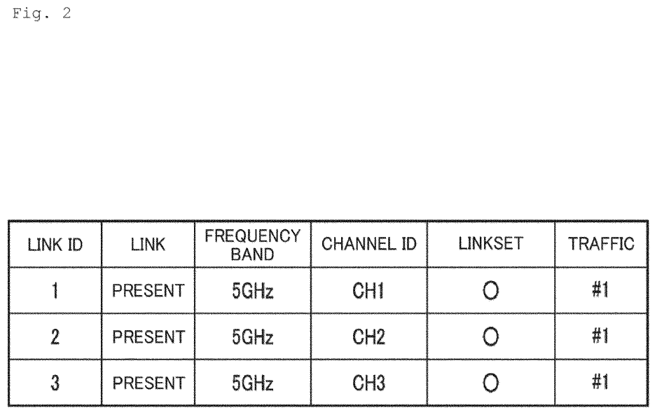

FIG. 2 schematically shows an example of link management information held by the terminal 20. The link management information shown in FIG. 2 indicates the state of the link between the access point 10 and the terminal 20. The link management information includes a link ID, frequency band information, a channel ID, link information, linkset information, and traffic information.

A link ID is an identifier (for example, an identification number) assigned to a link. Frequency band information is information indicating a frequency band used for a link. A channel ID is the identifier of a channel used for a link. In the example shown in FIG. 2, the terminal 20 can use three links. All three links use channels in the 5 GHz band, and the link with a link ID of 1 is currently using channel CH1 included in the 5 GHz band, the link with a link ID of 2 is currently using channel CH2 included in the 5 GHz band, and the link with a link ID of 3 is currently using channel CH3 included in the 5 GHz band. Note that the plurality of links in the linkset LS may be assigned different frequency bands, or may be assigned different channels in the same frequency band.

The link information indicates whether a link has been established between the access point 10 and the terminal 20. Linkset information indicates whether a linkset LS consisting of a plurality of links has been established between the access point 10 and the terminal 20. When a linkset LS is established, the linkset information indicates which links constitute the linkset LS. In the example shown in FIG. 2, the linkset LS is composed of three links with link IDs of 1 to 3.

The traffic information indicates a traffic indicator (TID) assigned to each link. The TID is an identifier that indicates each piece of traffic, and each piece of traffic may be associated with an access category. Access categories include, for example, voice (VO), video (VI), best effort (BE), and background (BK). In the example shown in FIG. 2, TID #1 corresponds to any one of VO, VI, BE, and BK. Then, TID #1 is assigned to each of the link whose link ID is 1, the link whose link ID is 2, and the link whose link ID is 3.

The access point 10 holds link management information similar to the link management information illustrated in FIG. 2 for each terminal wirelessly connected to the access point 10. That is, the link management information held by the access point 10 indicates the state of the link between the access point 10 and each terminal wirelessly connected to the access point 10.

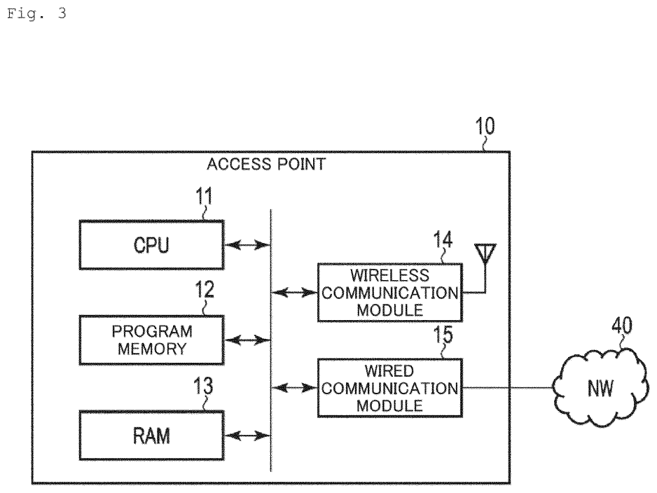

FIG. 3 schematically shows an example of the hardware configuration of the access point 10. As shown in FIG. 3, the access point 10 includes, for example, a central processing unit (CPU) 11, a program memory 12, a random access memory (RAM) 13, a wireless communication module 14, and a wired communication module 15.

The CPU 11 is an integrated circuit capable of executing various programs, and controls the overall operation of the access point 10. The program memory 12 is a nonvolatile semiconductor memory such as a read only memory (ROM) or a flash memory, and stores programs and control data for controlling the access point 10. The RAM 13 is, for example, a volatile semiconductor memory and is used as a working area of the CPU 11. The wireless communication module 14 is a circuit used to transmit and receive data using wireless signals and is connected to an antenna. The wireless communication module 14 includes a plurality of communication modules corresponding to a plurality of frequency bands. The wired communication module 15 is a circuit used for transmitting and receiving data using wired signals, and is connected to the communication network 40.

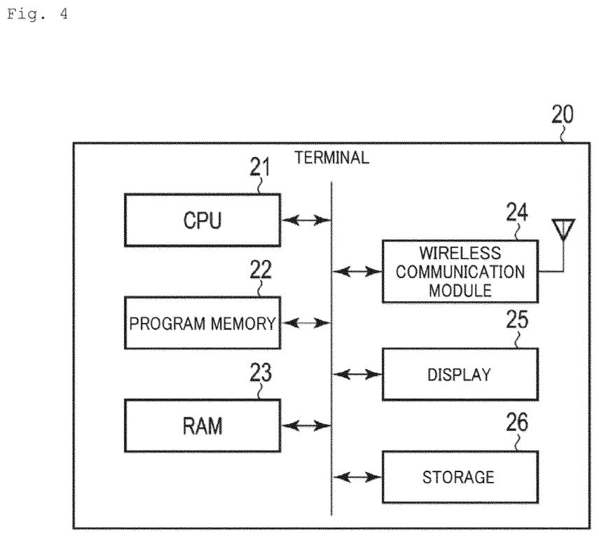

FIG. 4 schematically shows an example of the hardware configuration of the terminal 20. As shown in FIG. 4, the terminal 20 includes, for example, a CPU 21, a program memory 22, a RAM 23, a wireless communication module 24, a display 25, and a storage 26.

The CPU 21 is an integrated circuit capable of executing various programs, and controls the overall operation of the terminal 20. The program memory 22 is a nonvolatile semiconductor memory such as a ROM, and stores programs and control data for controlling the terminal 20. The storage 26 may be used as a program memory 22. The RAM 23 is, for example, a volatile semiconductor memory and is used as a working area of the CPU 21. The wireless communication module 24 is a circuit used to transmit and receive data using wireless signals, and is connected to an antenna. The wireless communication module 24 is configured to selectively perform a plurality of processes according to a plurality of channels. Specifically, the wireless communication module 24 is configured to perform processing according to a channel corresponding to one link that is adaptively selected from among a plurality of links. The display 25 displays information such as a graphical user interface (GUI) provided by application software, for example. The display 25 may have a function as an input interface of the terminal 20. For example, the touch panel may be provided on the display 25. The storage 26 is a nonvolatile storage device, and stores data including, for example, system software of the terminal 20.

The hardware configuration shown in FIG. 4 is an example, and the terminal 20 may have a different hardware configuration from that shown in FIG. 4. For example, if the terminal 20 is an IoT device or the like, the display 25 may be deleted from the terminal 20.

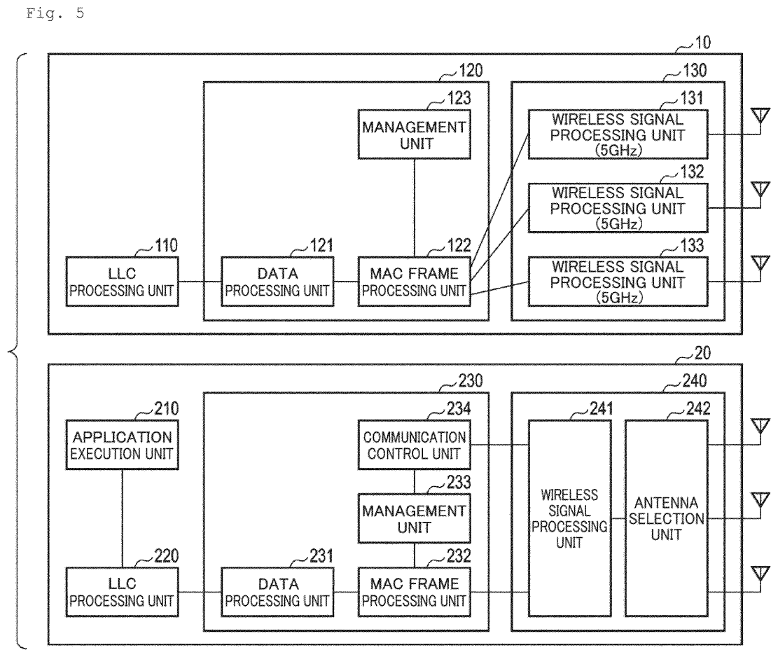

FIG. 5 schematically shows an example of the functional configuration of the access point 10 and the terminal 20. Here, processing related to uplink transmission will be mainly explained, and specific explanation of processing related to downlink transmission will be omitted. Downlink transmissions may be performed in a similar manner to the processing described for uplink transmissions. For example, the access point 10 can perform modulation processing similar to the modulation processing described below in relation to the terminal 20, and the terminal 20 can perform demodulation processing similar to the demodulation processing described below in relation to the access point 10. Uplink transmission refers to transmission from the terminal 20 to the access point 10, and downlink transmission refers to transmission from the access point 10 to the terminal 20.

As shown in FIG. 5, the access point 10 includes an LLC processing unit 110, a link management unit 120, and a communication unit 130. The LLC processing unit 110 may be implemented by a combination of the CPU 11 and the wired communication module 15. The link management unit 120 and the communication unit 130 may be implemented by the wireless communication module 14 or a combination of the CPU 11 and the wireless communication module 14.

The LLC processing unit 110 performs LLC layer processing and upper layer (third to seventh layers) processing on the input signal. For example, the LLC processing unit 110 receives an LLC packet from the link management unit 120 and extracts data from the LLC packet.

The link management unit 120 performs MAC layer processing on the input signal. Further, the link management unit 120 manages links with each terminal. The link management unit 120 includes a data processing unit 121, a MAC frame processing unit 122, and a management unit 123.

The data processing unit 121 receives the MAC frame from the MAC frame processing unit 122, extracts the LLC packet from the MAC frame, and transmits the LLC packet to the LLC processing unit 110.

Upon receiving the MAC frame from the communication unit 130, the MAC frame processing unit 122 transmits the MAC frame to the data processing unit 121 or the management unit 123 depending on the type of the MAC frame. Specifically, the MAC frame processing unit 122 transmits the MAC frame to the data processing unit 121 when the MAC frame is a data frame, and transmits the MAC frame to the management unit 123 when the MAC frame is a management frame or a control frame.

The management unit 123 manages links with each terminal based on information included in the management frame transmitted by each terminal. For example, the management unit 123 sets up a linkset with a terminal via the communication unit 130. Specifically, in response to receiving a connection request from the terminal 20, the management unit 123 performs association processing and subsequent authentication processing in order to establish multiple links between the access point 10 and the terminal 20. Data exchange between the access point 10 and the terminal 20 is performed using one of the links included in the linkset. Data exchange between the access point 10 and a terminal that follows a multilink operation and has established multiple links is performed using one or more links included in the linkset. The management unit 123 holds link management information as illustrated in FIG. 2. The access point 10 may negotiate with the terminal 20 a modulation and coding scheme (MCS) used for communication between the access point 10 and the terminal 20.

The management unit 123 performs r-TWT setup for each terminal that supports an r-TWT operation. For example, the management unit 123 sets an r-TWT service period and the link to be used during the r-TWT service period. The management unit 123 may set the r-TWT service period according to the period in which low-latency traffic occurs in the terminal. Specifically, the management unit 123 determines the time at which the r-TWT service period starts, the period of the r-TWT service period, and the duration of the r-TWT service period based on the occurrence period of low-latency traffic so that the r-TWT service period occurs in synchronization with the occurrence of low-latency traffic. The management unit 123 may obtain the occurrence period of low-latency traffic using any method. In one example, the management unit 123 may obtain a data occurrence period set for an application that generates low-latency traffic. The management unit 123 may dynamically determine the link to be used during the r-TWT period for each r-TWT service period.

The management unit 123 generates a beacon frame including service period information that specifies the r-TWT service period set for each terminal, and transmits it via the MAC frame processing unit 122 and the communication unit 130. A beacon frame is a type of management frame. Service period information may include information indicating the time when the r-TWT service period starts, information indicating the duration of the r-TWT service period, information indicating the period of the r-TWT service period, and information indicating the link to be used in the r-TWT service period. The service period information may further include information indicating a communication suspension period (quiet period) during which terminals other than those for which the r-TWT service period is set are suppressed from communicating. The start of the communication suspension period coincides with the start of the r-TWT service period. The communication suspension period may be shorter than the r-TWT service period.

The communication unit 130 wirelessly communicates with each terminal. The communication unit 130 includes a wireless signal processing unit 131 configured to transmit and receive wireless signals using a channel in the 5 GHz band, a wireless signal processing unit 132 configured to transmit and receive wireless signals using a channel in the 5 GHz band, and a wireless signal processing unit 133 configured to transmit and receive wireless signals using a channel in the 5 GHz band. Note that these channels are in the same frequency band but are different channels. The wireless signal processing unit 131 transmits and receives frames between the access point 10 and the terminal through wireless communication. Specifically, the wireless signal processing unit 131 performs physical layer processing on input data or wireless signals. For example, the wireless signal processing unit 131 receives a wireless signal from a terminal via an antenna, and performs predetermined demodulation processing on the received wireless signal to obtain a wireless frame. The predetermined demodulation processing includes, for example, frequency conversion, OFDM demodulation, fast Fourier transform (FFT), subcarrier demodulation, deinterleaving, and Viterbi decoding. The wireless signal processing unit 131 then extracts the MAC frame from the wireless frame and transmits the MAC frame to the MAC frame processing unit 122. The wireless signal processing units 132 and 133 perform the same processing as the wireless signal processing unit 131.

The terminal 20 includes an application execution unit 210, an LLC processing unit 220, a link management unit 230, and a communication unit 240. The application execution unit 210 and the LLC processing unit 220 may be implemented by the CPU 21. The link management unit 230 and the communication unit 240 may be implemented by the wireless communication module 24 or a combination of the wireless communication module 24 and the CPU 21.

The application execution unit 210 executes an application such as an application that exchanges data with the server 30 shown in FIG. 1. The LLC processing unit 220 executes LLC layer and upper layer processing on input data. For example, the LLC processing unit 220 receives data from the application execution unit 210, adds a DSAP header, an SSAP header, and the like to the data to generate an LLC packet, and transmits the LLC packet to the link management unit 230.

The link management unit 230 performs MAC layer processing on the input signal. Furthermore, the link management unit 230 manages links with the access point 10. The link management unit 230 includes a data processing unit 231, a MAC frame processing unit 232, a management unit 233, and a communication control unit 234.

The data processing unit 231 receives the LLC packet from the LLC processing unit 220, adds a MAC header to the LLC packet to generate a MAC frame, and transmits the MAC frame to the MAC frame processing unit 232. This MAC frame is a data frame.

The MAC frame processing unit 232 receives the MAC frame from the data processing unit 231 and transmits it to the communication unit 240. Further, upon receiving the MAC frame from the communication unit 240, the MAC frame processing unit 232 transmits the MAC frame to the data processing unit 231 or the management unit 233 depending on the type of the MAC frame. Specifically, the MAC frame processing unit 232 transmits the MAC frame to the data processing unit 231 when the MAC frame is a data frame, and transmits the MAC frame to the management unit 233 when the MAC frame is a management frame or a control frame.

The management unit 233 manages the link with the access point 10 based on information included in the management frame transmitted by the access point 10. For example, the management unit 233 sets up a linkset with the access point 10 via the communication unit 240. Specifically, the management unit 233 executes a protocol related to association, including transmitting a connection request to the access point 10, and executes a protocol related to authentication subsequent to the association. The management unit 233 holds link management information as illustrated in FIG. 2. The link management information is referenced by the communication control unit 234.

The management unit 233 extracts service period information that specifies the r-TWT service period set for each terminal from the beacon frame transmitted by the access point 10, and transmits the extracted service period information to the communication control unit 234.

The communication control unit 234 controls the operation of the communication unit 240. For example, the communication control unit 234 adaptively switches the link used for communication with the access point 10. Furthermore, the communication control unit 234 adjusts the timing of transmitting the data frame to the access point 10. The communication control unit 234 will be explained in detail later.

The communication unit 240 wirelessly communicates with the access point 10 under the control of the communication control unit 234. The communication unit 240 includes a wireless signal processing unit 241 and an antenna selection unit 242. The wireless signal processing unit 241 wirelessly transmits the MAC frame. For example, the wireless signal processing unit 241 generates a wireless frame by adding a preamble and a PHY (physical layer) header to the MAC frame, converts the wireless frame into a wireless signal by performing modulation processing according to the link (channel) specified by the communication control unit 234, and radiates the wireless signal via the antenna. Modulation processing includes, for example, convolutional coding, interleaving, subcarrier modulation, inverse fast Fourier transform (IFFT). orthogonal frequency division multiplexing (OFDM) modulation, and frequency conversion. The antenna selection unit 242 selects an antenna according to the link (channel) specified by the communication control unit 234.

Processing related to data frame transmission on the uplink will be briefly described.

When an application generates data to be transmitted to the server 30 (shown in FIG. 1), the application execution unit 210 transmits the data to the LLC processing unit 220. The LLC processing unit 220 receives data from the application execution unit 210, generates an LLC packet containing the data, and transmits the LLC packet to the data processing unit 231.

The data processing unit 231 receives the LLC packet from the LLC processing unit 220, generates a MAC frame from the LLC packet, and transmits the MAC frame to the MAC frame processing unit 232. The MAC frame processing unit 232 receives the MAC frame from the data processing unit 231 and transmits the MAC frame to the wireless signal processing unit 241.

The wireless signal processing unit 241 receives the MAC frame from the MAC frame processing unit 232, and temporarily stores the MAC frame. The wireless signal processing unit 241 wirelessly transmits the MAC frame according to instructions from the communication control unit 234. For example, the wireless signal processing unit 241 generates a wireless frame from a MAC frame, converts the wireless frame into a wireless signal by performing modulation processing according to the link (channel) specified by the communication control unit 234, and radiates the wireless signal through an antenna corresponding to a link (channel) specified by the communication control unit 234.

At the access point 10, the communication unit 130 receives a wireless signal from the terminal 20. One of the wireless signal processing units 131, 132, and 133 receives a wireless signal from the terminal 20. For example, when the terminal 20 uses a link whose link ID is 1, the wireless signal processing unit 131 receives a wireless signal from the terminal 20. The wireless signal processing unit 131 performs demodulation processing on the wireless signal to obtain a wireless frame. The wireless signal processing unit 131 extracts the MAC frame from the wireless frame and transmits the MAC frame to the MAC frame processing unit 122.

The MAC frame processing unit 122 receives a MAC frame from the communication unit 130. Since this MAC frame is a data frame, the MAC frame processing unit 122 transmits the MAC frame to the data processing unit 121.

The data processing unit 121 receives the MAC frame from the MAC frame processing unit 122, extracts the LLC packet from the MAC frame, and transmits the LLC packet to the LLC processing unit 110. The LLC processing unit 110 receives the LLC packet from the data processing unit 121, extracts data from the LLC packet, and transmits the data to the server 30 on the communication network 40.

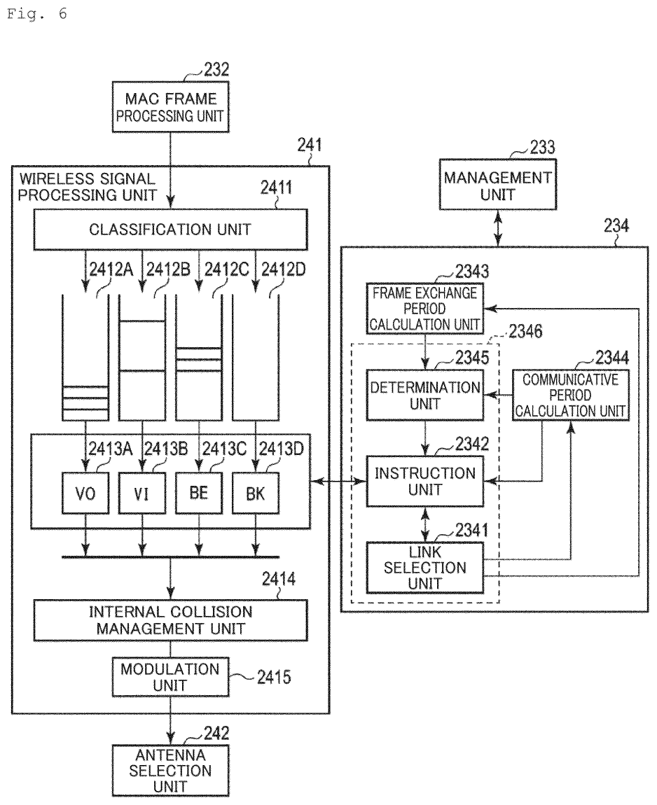

Data frame transmission in the terminal 20 will be described in detail with reference to FIG. 6. FIG. 6 schematically shows an example of the functional configuration of the communication control unit 234 and the wireless signal processing unit 241.

The wireless signal processing unit 241 includes a classification unit 2411, queues 2412A, 2412B, 2412C, and 2412D, carrier sense execution units 2413A, 2413B, 2413C, and 2413D, an internal collision management unit 2414, and a modulation unit 2415.

When a data frame is input to the wireless signal processing unit 241, the classification unit 2411 classifies the data frame into a plurality of access categories based on the TID included in the MAC header in the data frame. In the example shown in FIG. 6, the classification unit 2411 classifies data frames into four access categories: VO, VI, BE, and BK.

The classification unit 2411 inputs the data. frame into the queue 2412A when the data frame is classified into the access category VO, inputs the data frame into the queue 2412B when the data frame is classified into the access category VI, inputs the data frame into the queue 2412C when the data frame is classified into the access category BE, and inputs the data frame into the queue 2412D when the data frame is classified into the access category BK. Each of the queues 2412A, 2412B, 2412C, and 2412D buffers input data frames.

The carrier sense execution units 2413A, 2413B, 2413C, and 2413D are provided corresponding to the queues 2412A, 2412B, 2412C, and 2412D, respectively. The carrier sense execution units 2413A, 2413B, 2413C, and 2413D perform similar processing except that they use different access parameter sets. The access parameter set includes, for example, four access parameters: CWmin, CWmax, AIFS (Arbitration Inter Frame Space), and TXOP (Transmission Opportunity) Limit. Cwmin and CWmax indicate the minimum and maximum values of the contention window, respectively. The contention window is a parameter used to determine transmission waiting time for collision avoidance. AIFS indicates transmission waiting time. TXOP Limit indicates the upper limit of the channel occupation period TXOP. That is, the access category for which the shorter CWmin, CWmax, and AIFS are set, the easier it is to acquire the transmission right. Furthermore, the larger the TXOP Limit is set for the access category, the larger the amount of data that can be transmitted with one transmission right.

The carrier sense execution unit 2413A will be explained as a representative. The carrier sense execution unit 2413A executes carrier sense based on CSMA/CA for the link specified by the communication control unit 234 according to a preset access parameter set. When the carrier sense execution unit 2413A starts carrier sense, the carrier sense execution unit 2413A notifies the communication control unit 234 of the carrier sense state. For example, when the channel remains unused, the carrier sense execution unit 2413A notifies the communication control unit 234 of the scheduled time when the transmission right will be acquired and the channel occupation time. When the carrier sense execution unit 2413A detects that the channel is busy, it notifies the communication control unit 234 that carrier sense is to be interrupted.

Upon acquiring the transmission right, the carrier sense execution unit 2413A notifies the communication control unit 234 that the transmission right has been acquired. In response to the notification from the carrier sense execution unit 2413A, the communication control unit 234 transmits, to the carrier sense execution unit 2413A, any one of a transmission start signal instructing to start transmission, a link designation signal specifying a link, and a transmission postponement signal instructing postponement of transmission. Upon receiving the transmission instruction signal from the communication control unit 234, the carrier sense execution unit 2413A extracts the data frame from the queue 2412A and transmits the data frame to the internal collision management unit 2414. Upon receiving the link designation signal from the communication control unit 234, the carrier sense execution unit 2413A executes carrier sense for the link indicated by the link designation signal. Then, upon acquiring the transmission right, the carrier sense execution unit 2413A notifies the communication control unit 234 that the transmission right has been acquired. When the carrier sense execution unit 2413A receives a transmission postponement signal from the communication control unit 234, the carrier sense execution unit 2413A postpones transmission. For example, the carrier sense execution unit 2413A waits until it receives a link designation signal from the communication control unit 234.

The internal collision management unit 2414 prevents transmission collision when two or more carrier sense execution units acquire transmission rights at the same time. Specifically, when receiving data frames from two or more carrier sense execution units at the same time, the internal collision management unit 2414 transmits a data frame of an access category with a higher priority to the modulation unit 2415 in order to transmit a data frame of an access category with a higher priority.

The modulation unit 2415 receives the data frame from the internal collision management unit 2414, and performs modulation processing on the data frame according to the channel corresponding to the link for which the transmission right has been acquired.

The communication control unit 234 includes a link selection unit 2341, an instruction unit 2342, a frame exchange period calculation unit 2343, a communicative period calculation unit 2344. and a determination unit 2345. The communication control unit 234 performs similar processing on each of the carrier sense execution units 2413A, 2413B, 2413C, and 2413D. Here, the exchange between the communication control unit 234 and the carrier sense execution unit 2413A will be explained.

The link selection unit 2341 selects one link from among the links established with the access point 10, and notifies the instruction unit 2342 of the selected link. The link selection unit 2341 refers to link management information held by the management unit 233 for link selection. The link selection unit 2341 identifies a link established with the access point 10 based on the link management information. When the link management information is the link management information shown in FIG. 2, three links 1 to 3 are established between the access point 10 and the terminal 20. Here, link N refers to a link whose link ID is N.

The instruction unit 2342 exchanges information with the carrier sense execution unit 2413A. The instruction unit 2342 issues an instruction to the carrier sense execution unit 2413A. For example, upon receiving the notification from the link selection unit 2341, the instruction unit 2342 transmits a link designation signal indicating the link selected by the link selection unit 2341 to the carrier sense execution unit 2413A.

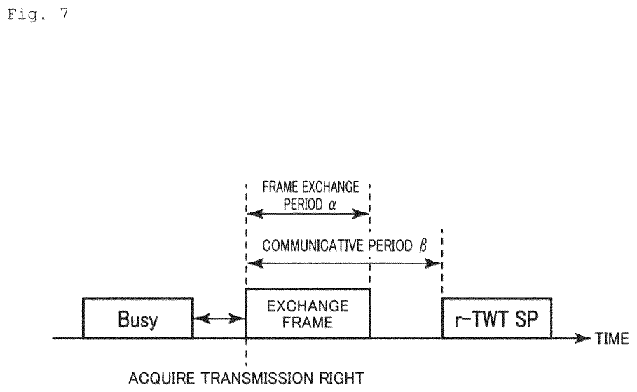

The frame exchange period calculation unit 2343 calculates a frame exchange period including the time period required for transmitting a data frame to the access point 10. The frame exchange period indicates the time period required for frame exchange between the access point 10 and the terminal 20. The frame exchange period may indicate the period from the time when the transmission right is acquired to the time when processing related to data frame transmission to the access point 10 ends, indicated by u in FIG. 7. The processing related to transmitting a data frame to the access point 10 may refer to processing of transmitting the data frame to the access point 10, or may refer to a series of processing of transmitting the data frame to the access point 10 and receiving a response to the data frame (for example, an acknowledgment (ACK)) from the access point 10. In other words, the frame exchange period may indicate the time period required to transmit a data frame to the access point 10, or may also indicate the time period required to transmit a data frame to the access point 10 and receive a response to the data frame from the access point 10.

For example, the frame exchange period calculation unit 2343 receives information indicating the size of the data frame to be transmitted (the data frame held at the head of the queue 2412A) from the carrier sense execution unit 2413A via the instruction unit 2342, and receives information indicating the MCS applied to data frame transmission to the access point 10 from the management unit 233. The frame exchange period calculation unit 2343 calculates the time period required to transmit the data frame to the access point 10 based on the size of the data frame to be transmitted, the MCS applied to the data frame transmission, and the transmission waiting time calculated by the average backoff value determined by the contention window. The transmission waiting time calculated by the average backoff value determined by the contention window corresponds to the overhead related to acquiring the transmission right.

The communicative period calculation unit 2344 calculates the communicative period, which indicates the time period until the start of the r-TWT service period, for the link selected by the link selection unit 2341. The communicative period may indicate the period from the time when the transmission right is acquired to the time when the r-TWT service period starts, which is indicated by 3 in FIG. 7. The communicative period calculation unit 2344 checks whether an r-TWT service period is scheduled for the link selected by the link selection unit 2341. The r-TWT service period may be set for the terminal 20 or may be set for another terminal. If the r-TWT service period is set for another terminal. the start of the r-TWT service period refers to the start of the communication suspension period.

When the r-TWT service period is scheduled, the communicative period calculation unit 2344 calculates the communicative period. If the r-TWT service period is not scheduled, the communicative period calculation unit 2344 notifies the instruction unit 2342 that the r-TWT service period is not scheduled. Alternatively, the communicative period calculation unit 2344 may set the communicative period to a value indicating a sufficiently long period.

When the instruction unit 2342 receives a notification from the communicative period calculation unit 2344 indicating that the r-TWT service period is not scheduled, the instruction unit 2342 transmits a transmission start signal to the carrier sense execution unit 2413A.

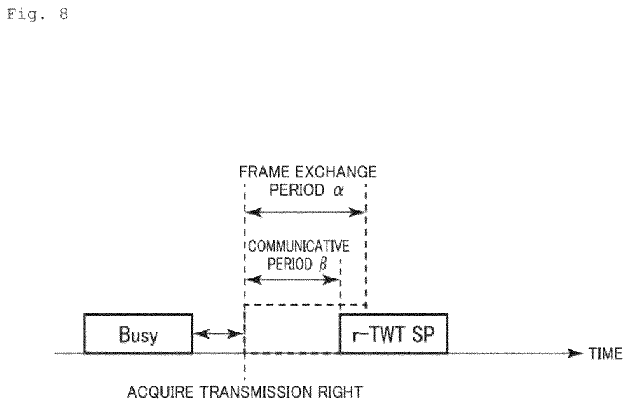

Based on the comparison between the frame exchange period calculated by the frame exchange period calculation unit 2343 and the communicative period calculated by the communicative period calculation unit 2344, the determination unit 2345 determines whether frame exchange including data frame transmission will end before the start of the r-TWT service period. The determination unit 2345 determines that the frame exchange will end before the start of the r-TWT service period when the frame exchange period is less than or equal to the communicative period as shown in FIG. 7, and determines that the frame exchange will not end before the start of the r-TWT service period when the frame exchange period is longer than the communicative period as shown in FIG. 8. The determination unit 2345 notifies the instruction unit 2342 of the determination result.

The instruction unit 2342 receives the determination result from the determination unit 2345. If the determination result indicates that the data frame transmission will end before the start of the r-TWT service period, the instruction unit 2342 transmits a transmission start signal to the carrier sense execution unit 2413A. If the determination result indicates that the data frame transmission will not end before the start of the r-TWT service period, the instruction unit 2342 instructs the link selection unit 2341 to select a link. Upon receiving the instruction from the link selection unit 2341, the link selection unit 2341 selects another link and notifies the instruction unit 2342 of the selected link. Upon receiving the notification from the link selection unit 2341, the instruction unit 2342 transmits a link designation signal to the carrier sense execution unit 2413A. If there is no selectable link, the link selection unit 2341 notifies the instruction unit 2342 that there is no selectable link. Upon receiving the notification from the link selection unit 2341, the instruction unit 2342 transmits a transmission postponement signal to the carrier sense execution unit 2413A.

The link selection unit 2341, the instruction unit 2342, and the determination unit 2345 may be collectively referred to as transmission control unit 2346. The transmission control unit 2346 is configured to transmit the data frame on the first link via the communication unit 240 when the frame exchange period is less than or equal to the communicative period for the first link (for example, link 1) and attempt to transmit the data frame on the second link (for example, link 2) when the frame exchange period is longer than the communicative period for the first link. Attempting to transmit a data frame on the second link may include checking whether an r-TWT service period is scheduled for the second link and instructing the communicative period calculation unit 2344 to calculate the communicative period for the second link when the r-TWT service period is scheduled for the second link. Attempting to transmit a data frame on the second link may include transmitting a data frame on the second link when the transmission right for the second link is acquired and the r-TWT service period is not scheduled for the second link and transmitting a data frame on the second link via the communication unit 240 when the transmission right for the second link is acquired and the frame exchange period is less than or equal to the communicative period for the second link. When the frame exchange period is longer than the communicative period for the second link, the transmission control unit 2346 may be further configured to attempt to transmit data frames on the third link or to postpone data frame transmission.

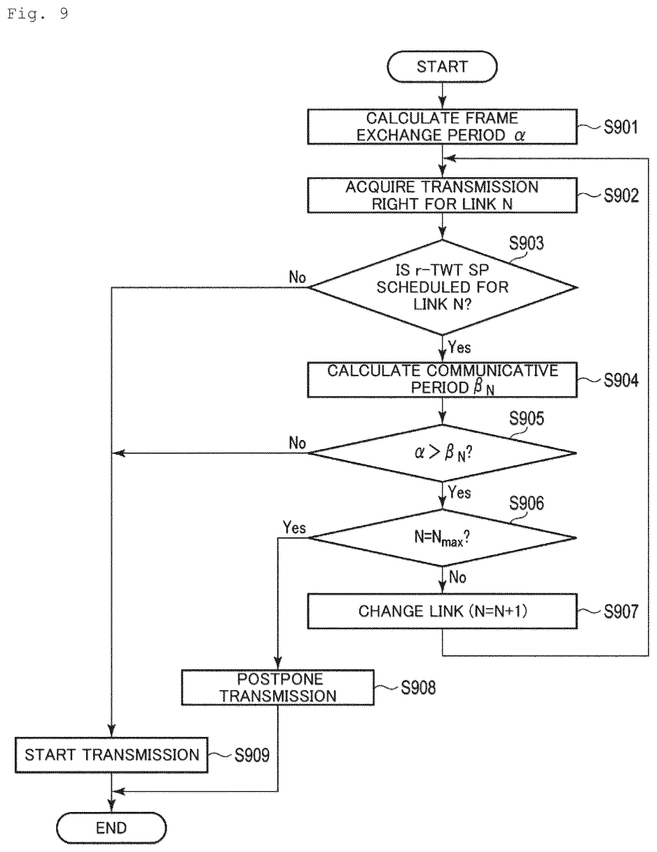

FIG. 9 schematically shows a wireless communication method according to an embodiment. Specifically, FIG. 9 schematically shows an example of a method by which the terminal 20 wirelessly transmits a data frame to the access point 10. The processing shown in FIG. 9 is executed. individually for each access category. Here, processing for access category VO will be explained. Let Nₘₐₓ be the number of links established between the access point 10 and the terminal 20.

In step S901 in FIG. 9, the frame exchange period calculation unit 2343 calculates a frame exchange period α that includes the time period required for transmitting a data frame to the access point 10. For example, the frame exchange period calculation unit 2343 calculates the time period required to transmit the data frame to the access point 10 based on the size of the data frame to be transmitted and the MCS applied to data frame transmission, and adds the time required to receive an ACK from the access point 10 and the overhead associated with acquiring the transmission right to the calculated time period to obtain the frame exchange period α.

After the processing shown in step S901 is executed, the link selection unit 2341 sets the variable N to 1 and selects link 1 (the link whose link ID is 1). The instruction unit 2342 transmits a link designation signal indicating the selected link 1 to the carrier sense execution unit 2413A.

In step S902, the carrier sense execution unit 2413A performs carrier sense for link N and acquires the transmission right for link N.

In step S903, the communicative period calculation unit 2344 checks whether an r-TWT service period has been scheduled for link N.

If no r-TWT service period has been scheduled for link N (step S903; No), the processing proceeds to step S909. In step S909, the transmission control unit 2346 transmits the data frame to the access point 10 on link N via the communication unit 240. For example, the instruction unit 2342 transmits a transmission start signal to the carrier sense execution unit 2413A. In response to receiving the transmission start signal from the instruction unit 2342, the carrier sense execution unit 2413A extracts a data frame from the queue 2412A and transmits the data frame to the modulation unit 2415 via the internal collision management unit 2414. The modulation unit 2415 performs modulation processing on the data frame according to link N to generate a wireless signal, and transmits the wireless signal via the antenna.

If an r-TWT service period has been scheduled for link N (step S903; Yes), the processing proceeds to step S904. In step S904, the communicative period calculation unit 2344 calculates the communicative period β_{N} for link N. The communicative period β_{N} for link N may indicate the time interval from the reference time to the time when the r-TWT service period starts. The reference time indicates the time when data frame transmission can be started. The is time at which the transmission right for link N was acquired may be used as the reference time.

In step S905, the determination unit 2345 determines whether the frame exchange period α is longer than the communicative period β_{N} for link N.

If the frame exchange period α is not longer than the communicative period β_{N} for link N (step S905; No), the processing proceeds to step S909. In step S909, the communication unit 240 transmits the data frame to the access point 10 on link N.

If the frame exchange period α is longer than the communicative period β_{N} for link N (step S905; Yes), the processing proceeds to step S906. In step S906, the link selection unit 2341 determines whether the variable N is equal to the number of links Nₘₐₓ.

If the variable N is not equal to the number of links Nₘₐₓ (step S906; No), the processing proceeds to step S907. In step S907, the link selection unit 2341 determines to change the link used for data frame transmission. For example, the link selection unit 2341 increases the variable N by 1, and selects link N. The instruction unit 2342 transmits a link designation signal indicating link N to the carrier sense execution unit 2413A. The processing returns to step S902.

If the variable N is equal to the number of links Nₘₐₓ (step S906; Yes), the processing proceeds to step S908. Tn step S908, the transmission control unit 2346 postpones data frame transmission. For example, the link selection unit 2341 notifies the instruction unit 2342 that there is no selectable link, and the instruction unit 2342 transmits a transmission postponement signal to the carrier sense execution unit 2413A.

The processing shown in FIG. 9 is only an example. For example, the processing shown in step S901 may be executed after it is determined that an r-TWT service period is scheduled for link 1. If the frame exchange period α is equal to the communicative period β_{N} for link N, the processing may proceed from step S905 to step S906.

As described above, the terminal 20 establishes links 1 to 3 with the access point 10, and selectively uses links 1 to 3 to transmit data frames to the access point 10. The terminal 20 calculates a frame exchange period that includes the time period required to transmit the data frame to the access point 10. The terminal 20 calculates the communicative period for link 1 when the transmission right for link 1 is acquired and the r-TWT service period is scheduled for link 1. The communicative period for link 1 indicates the time period until the start of the r-TWT service period scheduled for link 1. The terminal 20 transmits data frames on link 1 when the frame exchange period is less than or equal to the communicative period for link 1, and attempts to transmit data frames on link 2 when the frame exchange period is longer than the communicative period for link 1. For example, when attempting to transmit a data frame on link 2, the terminal 20 performs carrier sense for link 2 and acquires the right to transmit on link 2. The terminal 20 calculates the communicative period for link 2 when a service period is scheduled for link 2. The terminal 20 performs data frame transmission on the second link when the frame exchange period is less than or equal to the communicative period for link 2. Additionally, the terminal 20 transmits data frames on link 2 when no service period is scheduled for link 2.

According to the above-described configuration, if data frame transmission cannot be completed on link 1 by the start of the r-TWT service period, data frame transmission can be performed on link 2. When data frame transmission is performed on link 2, a situation in which data frame transmission is postponed due to the r-TWT service period is avoided. Therefore, the frequency of occurrence of situations in which data frame transmission is postponed due to the r-TWT service period is reduced, and it is possible to effectively avoid the occurrence of collisions or decrease in frequency utilization efficiency. As a result, throughput and latency characteristics are improved. Furthermore, even when the terminal 20 cannot simultaneously transmit and receive frames on multiple links, appropriate link selection is possible.

The terminal 20 may attempt to transmit data frames on link 3 if the frame exchange period is longer than the communicative period for link 2. By attempting to transmit data frames on a larger number of links, the frequency of occurrence of situations in which data frame transmission is postponed due to the r-TWT service period is reduced, making it possible to more effectively prevent collisions or decreases in frequency utilization efficiency. As a result, throughput and latency characteristics are further improved.

The terminal 20 may transmit data frames on link 2 in response to the r-TWT service period not being scheduled for link 2. According to this configuration, the calculation and determination processing of the communicative period can be omitted, and the processing cost can be reduced.

### Modified Example

In the embodiment described above, the link selection unit 2341 selects links in order of link ID. Link selection may be performed according to other criteria. In one example, the link selection unit 2341 may select links in descending order of the number of times the r-TWT service period has been set. In this case, the management unit 233 counts up each time the r-TWT service period is set for each link. Links that have fewer r-TWT service periods are less likely to have r-TWT service periods scheduled and therefore more likely to be able to transmit data frames. Therefore, it is expected that the processing shown in FIG. 9 will reach the conclusion that data frame transmission is to be performed at an earlier stage. In other words, it is expected that the resources required for processing can be reduced. In another example, the link selection unit 2341 may select links in descending order of the number of times the frame exchange period is determined to be less than or equal to the communicative period. In this case as well, it is expected that the processing shown in FIG. 9 will reach the conclusion that data frame transmission is to be performed at an earlier stage, and it is expected that the resources required for the processing can be reduced.

In the embodiment described above, the frame exchange period α is calculated every time a data frame is transmitted. In some data frame transmissions, a statistical average or median value of frame exchange periods calculated over a certain time period may be used as the frame exchange period α.

In the embodiment described above, the communicative period β_{N} for link N is calculated every time the transmission right is acquired. In some cases where the transmission right is acquired, a statistical average or median value of the communicative period for link N calculated over a certain time period may be used as the communicative period β_{N} for link N.

In a multilink operation, a TID may be associated with a link. Each link is used to transmit and receive traffic for the TID associated with that link. For example, TID #1 is associated with links 1 to 3, TID #2 is associated with link 1, TID #3 is associated with link 2, and TID #4 is associated with link 3. In this case, traffic with TID of #1 is transmitted using any of links 1 to 3, traffic with TID of #2 is transmitted using link 1, traffic with TID of #3 is transmitted using link 2, and traffic with TID of #4 is transmitted using link 3. The association between the TID and the link (TID-to-link mapping) may be performed when a linkset is established between the access point 10 and the terminal 20.

In the processing shown in FIG. 9, the TID of traffic included in the data frame may be considered. Specifically, a series of processing shown in steps S902 to S905 may be executed for the link associated with the TID of traffic. For example, a step is provided between step S901 and step S902 to determine whether link N is associated with the TID of traffic included in the data frame. Processing proceeds to step S902 if link N is associated with the TID of traffic, and processing proceeds to step S906 if link N is not associated with the TID of traffic.

In the embodiments described above, the terminal 20 is a terminal operating in the EMLSR mode. The terminal 20 may be a terminal that follows a multilink operation with multiple links established.

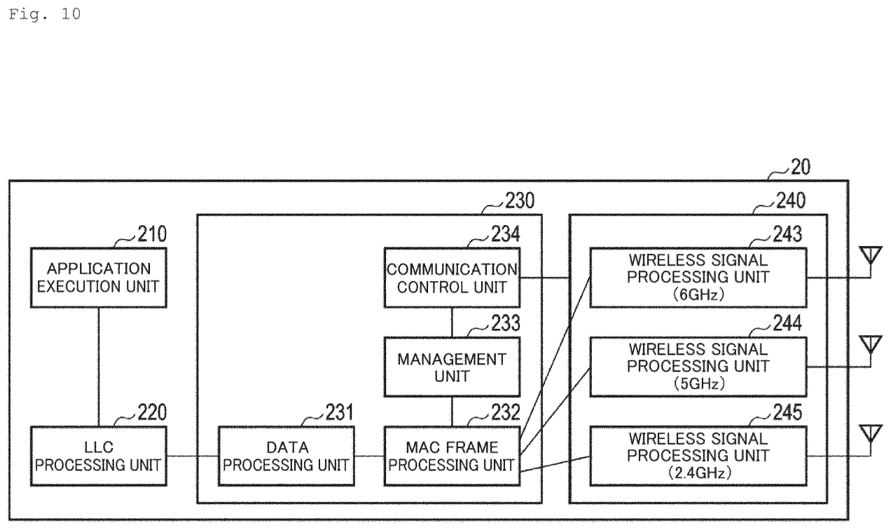

FIG. 10 schematically shows an example of a functional configuration of the terminal 20 that follows the multilink operation in which a plurality of links is established according to the embodiment. In FIG. 10, the same elements as those shown in FIG. 5 are given the same reference numerals, and redundant explanation will be omitted.

As shown in FIG. 10, the terminal 20 includes an application execution unit 210, an LLC processing unit 220, a link management unit 230, and a communication unit 240. The link management unit 230 includes a data processing unit 231, a MAC frame processing unit 232, a management unit 233, and a communication control unit 234. The communication unit 240 includes a wireless signal processing unit 243 configured to transmit and receive wireless signals using a channel in the 6 GHz band, a wireless signal processing unit 244 configured to transmit and receive wireless signals using a channel in the 5 GHz band, and a wireless signal processing unit 245 configured to transmit and receive wireless signals using a channel in the 2.4 GHz band. In this case, the access point 10 also includes a wireless signal processing unit configured to transmit and receive wireless signals using a channel in the 6 GHz band, and a wireless signal processing unit configured to transmit and receive wireless signals using a channel in the 5 GHz band, and a wireless signal processing unit configured to transmit and receive wireless signals using a channel in the 2.4 GHz band. The wireless signal processing units 243, 244, and 245 are associated with links 1, 2, and 3, respectively. The communication unit 240 communicates with the access point 10 using one or more wireless signal processing units associated with the one or more links selected by the communication control unit 234.

In the terminal 20 having the configuration shown in FIG. 10, the classification unit 2411, the queues 2412A, 2412B, 2412C, and 2412D, the carrier sense execution units 2413A, 2413B, 2413C, and 2413D, the internal collision management unit 2414, and the modulation unit 2415 shown in FIG. 6 are provided in each of the wireless signal processing units 243, 244, and 245. Note that the classification unit 2411, the queues 2412A, 2412B, 2412C, and 2412D, the carrier sense execution units 2413A, 2413B, 2413C, and 2413D, the internal collision management unit 2414, and the modulation unit 2415 may be provided in the MAC frame processing unit 232. Further, the classification unit 2411 and the queues 2412A, 2412B, 2412C, and 2412D may be provided in the MAC frame processing unit 232, and the carrier sense execution units 2413A, 2413B, 2413C, and 2413D, and the internal collision management unit 2414 may be provided in the wireless signal processing units 243, 244. and 245.

In the terminal 20 shown in FIG. 10, the communication control unit 234 can operate in the same manner as described with reference to FIGS. 6 and 9. Therefore, a detailed explanation of the operation of the communication control unit 234 will be omitted.

In the embodiment described above, it is assumed that the terminal 20 is a transmitting station and the access point 10 is a receiving station. In situations in which the access point 10 is a transmitting station and the terminal 20 is a receiving station, the access point 10 may perform data frame transmission in a manner similar to that described above with respect to the terminal 20. That is, the access point 10 may include components equivalent to the communication control unit 234 of the terminal 20.

The wireless communication function provided by the wireless station (the access point 10 and the terminal 20) may be implemented by discrete components such as chips. For example, the chips may be integrated into the substrate of the wireless station when the wireless station is manufactured. The wireless device referred to herein may refer to a wireless station, or may refer to an discrete component that implements the wireless communication functionality of a wireless station.

Note that the present invention is not limited to the embodiments described above and can variously be modified at an execution stage within a scope not departing from the gist of the present invention. In addition, the embodiments may be combined as appropriate, and in such a case, combined effects can be achieved. Furthermore, the above embodiments include various inventions, and various inventions can be extracted by a combination selected from a plurality of disclosed components. For example, even if some components are deleted from all the components described in the embodiments, in a case where the problem can be solved and the effects can be obtained, a configuration from which the components are deleted can be extracted as an invention.

### REFERENCE SIGNS LIST

10 Access point
11 CPU
12 Program memory
13 RAM
14 Wireless communication module
15 Wired communication module
20 Terminal.
21 CPU
22 Program memory
23 RAM
24 Wireless communication module
25 Display
26 Storage
30 Server
40 Communication network
45 Wireless network
50 Communication system
110 LLC processing unit
120 Link management unit
121. Data processing unit
122 MAC frame processing unit
123 Management unit
130 communication unit
131, 132, 133 Wireless signal processing unit
210 Application execution unit
220 LLC processing unit
230 Link management unit
231 Data processing unit
232 MAC frame processing unit
233 Management unit
234 Communication control unit
240 communication unit
241 Wireless signal processing unit
242 Antenna selection unit
243, 244, 245 Wireless signal processing unit
2341 Link selection unit
2342 Instruction unit
2343 Frame exchange period calculation unit
2344 Communicative period calculation unit
2345 Determination unit
2346 Transmission control unit
2411 Classification unit
2412A, 2412B, 2412C, 2412D Queue
2413A, 2413B, 2413C, 2413D Carrier sense execution unit
2414 Internal collision management unit
2415 Modulation unit

1. A wireless apparatus comprising:
a wireless communication module configured to wirelessly communicate with another wireless apparatus using a plurality of links established between the wireless apparatus and the other wireless apparatus; and
processing circuitry, the processing circuitry being configured to:
calculate a frame exchange period including a time period required for frame transmission to the other wireless apparatus;
calculate a communicative period indicating a time period until the start of a service period during which a transmission opportunity is given, wherein the calculating the communicative period includes calculating the communicative period for the first link when the service period is scheduled for the first link; and
perform the frame transmission on the first link when the frame exchange period is shorter than the communicative period for the first link and attempt to perform the frame transmission on a second link different from the first link included in the plurality of links when the frame exchange period is longer than the communicative period for the first link.

2. The wireless apparatus according to claim 1, wherein
the attempting to perform the frame transmission on the second link includes:
determining whether the service period is scheduled for the second link,
calculating the communicative period for the second link when the service period is scheduled for the second link, and
performing the frame transmission on the second link when the frame exchange period is shorter than the communicative period for the second link.

3. The wireless apparatus according to claim 2, wherein the processing circuitry is further configured to attempt to perform the frame transmission on a third link different from the first link and the second link included in the plurality of links when the frame exchange period is longer than the communicative period for the second link.

4. The wireless apparatus according to claim 2, wherein the processing circuitry is further configured to perform the frame transmission on the second link in response to the service period not being scheduled for the second link.

5. A wireless communication method performed by a wireless apparatus, the method comprising:
wirelessly communicating with another wireless apparatus using a plurality of links established between the wireless apparatus and the other wireless apparatus;
calculating a frame exchange period including a time period required for frame transmission to the other wireless apparatus;
calculating a communicative period indicating a time period until the start of a service period during which a transmission opportunity is given, wherein the calculating including calculating the communicative period for the first link when the service period is scheduled for the first link; and
performing the frame transmission on the first link when the frame exchange period is shorter than the communicative period for the first link and attempting to perform the frame transmission on a second link different from the first link included in the plurality of links when the frame exchange period is longer than the communicative period for the first link.
